(19) United States
(12) Patent Application Publication
(10) Pub. No.: US 2008/0228621 A1
(43) Pub. Date: Sep. 18, 2008

(54) System And Method For Transfer Of Dispute Data In A Distributed Electronic Trading System

(76) Inventor: James C. Johnson, Cresskill, NJ (US)

Correspondence Address: BAKER BOTTS L.L.P., 2001 ROSS AVENUE, SUITE 600, DALLAS, TX, 75201-2980, US

(21) Appl. No.: 11/687,009

(22) Filed: Mar. 16, 2007

(51) Int. Cl. G06Q 40/00

(52) U.S. Cl. 705/37

(57) ABSTRACT

A system for dispute data transfer in a distributed trading network includes a memory and a dispute manager. The memory stores information about a trading order associated with a client system. The dispute manager communicates a confirmation message to the client system, where the confirmation message provides an option to send a trading order dispute request that disputes processing of the trading order. The dispute manager receives a trading order dispute request generated in response to a selection of the option. The dispute manager obtains a decision that responds to the trading order dispute request and communicates the decision to the client system.

### TECHNICAL FIELD

This invention relates generally to the field of distributed data processing systems and more specifically to a system and method for the transfer of dispute data in a distributed electronic trading system.

### BACKGROUND

In recent years, electronic trading systems have gained widespread acceptance for trading a wide variety of items, such as goods, services, financial instruments, and commodities. For example, electronic trading systems may be used to trade stocks, fixed income securities, currencies, futures contracts, oil, and gold.

A trader may submit a trading order to a trading system in order to initiate a trade. The trading system may process the trading order to determine whether the order can be satisfied, and then send the results to the trader. In some cases, the trader may want to dispute the processing of the trading order.

Known techniques for disputing the processing of a trading order involve contacting a representative of the trading system and registering a complaint. These known techniques, however, are not efficient in certain situations. It is generally desirable to be efficient in certain situations.

### SUMMARY OF THE DISCLOSURE

In accordance with the present invention, disadvantages and problems associated with previous techniques for disputing the processing of a trading order may be reduced or eliminated.

According to one embodiment, a system for dispute data transfer in a distributed trading network includes a memory and a dispute manager. The memory stores information about a trading order associated with a client system. The dispute manager communicates a confirmation message to the client system, where the confirmation message provides an option to send a trading order dispute request that disputes processing of the trading order. The dispute manager receives a trading order dispute request generated in response to a selection of the option. The dispute manager obtains a decision that responds to the trading order dispute request and communicates the decision to the client system.

Certain embodiments of the invention may provide one or more technical advantages. A technical advantage of one embodiment may be that a dispute manager of a trading system may automatically manage a trading order dispute that raises an objection to the processing of a trading order. The dispute manager may provide a trader the option to submit a trading order dispute request to dispute the trading order. Accordingly, the dispute manager may allow a trader to efficiently dispute a trading order.

Another technical advantage of one embodiment may be that the dispute manager may obtain a decision that responds to the trading order dispute request. In a first example, the dispute manager may obtain a decision by forwarding the trading order dispute request to a governing entity, which sends the decision to the dispute manager. In a second example, the dispute manager may obtain a decision by applying dispute resolution rules to the trading order dispute request to establish the decision. Accordingly, the dispute manager may provide a relatively quick response to a trading order dispute request. In some situations, the quick response may yield a speedy resolution to a trading order dispute. Such a resolution of trading order disputes with reduce network disputes and thereby save bandwidth.

Another technical advantage of one embodiment may be that the dispute manager may manage different aspects of trade dispute resolution. For example, the dispute manager may handle trading order dispute requests and obtain decisions that respond to the trading order dispute requests. Accordingly, the dispute manager may provide management of trade dispute resolution at a centralized location.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 illustrates one embodiment of a trading system operable to receive and execute trading orders from traders;

FIG. 2 is a diagram illustrating one embodiment of a graphical user interface (GUI) that may be used to submit a trading order dispute request; and

FIG. 3 is a flowchart illustrating one embodiment of a method for processing a trading order that may be used with the system of FIG. 1.

### DETAILED DESCRIPTION OF THE DRAWINGS

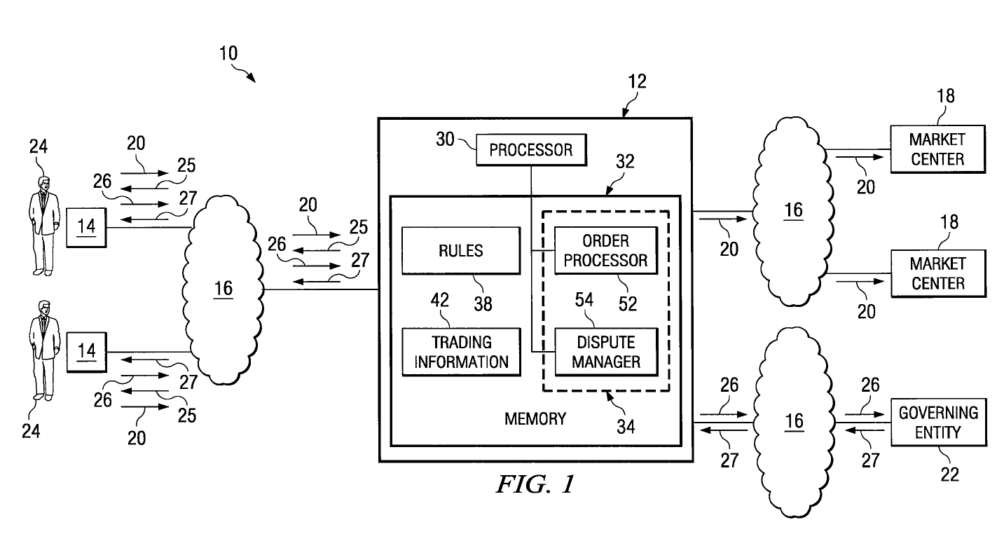

Embodiments of the present invention and its advantages are best understood by referring to FIGS. 1 through 3 of the drawings, like numerals being used for like and corresponding parts of the various drawings.

FIG. 1 illustrates one embodiment of a trading system 10 operable to receive and execute trading orders 20 from traders 24. According to one embodiment, a trading platform 12 is coupled to one or more client systems 14, one or more market centers 18, and a governing entity 22 via one or more networks 16.

In one example of operation, trader 24 may submit trading order 20. For example, trader 24 may send trading order 20 to buy a trading product that has been trading consistently at $2.00 per share. Trader 24 may receive a confirmation message 25 indicating that trading order 20 was filled. In the example, trading order 20 may be filled at $10.00 per share. Trader 24 may wish to dispute one or more parameters of this transaction, such as the price per share.

Trader 24 may submit a trading order dispute request 26 to dispute the processing of trading order 20. Dispute manager 54 may obtain a decision 27 in response to trading order dispute request 26. In the example, dispute manager 54 may establish whether the price discrepancy was due to a legitimate reason, such as a transitory spike in the price of the product, or due to an error, such as a computer problem.

Dispute manager 54 may obtain a decision 27 by forwarding trading order dispute request 26 to governing entity 22. Governing entity 22 determines an appropriate resolution to the dispute, as described in greater detail below, and sends the decision 27 to dispute manager 54. Alternatively, dispute manager 54 may obtain a decision 27 by applying dispute resolution rules 38 to trading order dispute request 26 to establish the decision 27. Dispute manager 54 may then send the decision 27 to trader 24.

According to one embodiment, traders 24 may represent users of trading system 10 capable of placing and/or responding to trading orders 20. A trader 24 may represent a principal, an agent acting on behalf of a principal, an individual, a legal entity (such as a corporation), or any machine or mechanism that is capable of placing and/or responding to trading orders 20.

A trading order 20 may represent an order to buy or sell a particular amount of a particular trading product. A trading product may refer to any suitable product or combination of products that forms the basis of a given trading order 20. Examples of trading products may include any type of goods, services, financial instruments, commodities, equities, stocks, fixed income securities, interest rate derivatives, currencies, futures contracts, debentures, options, securities, derivative trading instruments, or any other suitable product or combination of products.

A trading order 20 may include trading order parameters that specify particular values for variables of trading order 20. Examples of trading order parameters may include a quantity of a trading product, a type of trading product, a target price, other parameters describing a trading order 20, or any combination of the preceding. A target price may refer to a target bid price and/or target offer price.

A client system 14 may represent any suitable end-user element that may be used by traders 24 to access one or more elements of trading system 10, such as trading platform 12. Examples of an end-user element include a computer, a workstation, a telephone, an Internet browser, an electronic notebook, a personal digital assistant (PDA), a pager, or any other suitable device (wireless or otherwise) capable of receiving, processing, storing, and/or communicating information with other components of system 10.

A network 16 may represent a communication platform operable to exchange information. A communication network may comprise at least a portion of a plain old telephone system (POTS), a public switched telephone network (PSTN), a public or private data network, a local area network (LAN), a metropolitan area network (MAN), a wide area network (WAN), a local, regional, or global communication or computer network such as the Internet, a wireline or wireless network, an enterprise intranet, other suitable communication link, or any combination of the preceding.

Governing entity 22 may represent one or more computing devices associated with any suitable entity empowered to make a decision 27 for a trading order dispute request 26. The entity may be a private or public group, and may operate as a part of or independently of trading system 12. The entity may comprise an agency, a company, one or more people, an institution, or other entity.

Trading platform 12 may represent a trading architecture that facilitates the processing of trading orders 20 and the management of trading accounts. Trading platform 12 may be configured at a management center or a headquartering office for any person, business, or entity that seeks to manage the trading of orders 20. Trading platform 12 may include any suitable combination of logic, personnel, devices, or entities that may be utilized to perform the operations of an administrative body or a supervising entity that manages or administers a trading environment.

According to the illustrated embodiment, trading platform 12 may comprise a processor 30 and a memory 32 coupled as shown. Processor 30 may execute instructions of applications 34 and manipulate data of memory 32. Processor 30 may comprise logic, which may comprise hardware, software, other logic, or any suitable combination of the preceding that may be used to provide information or instructions.

Memory 32 may store applications 34, one or more rules 38, and trading information 42. Applications 34 may include an order processor 52 and an account manager 54. Order processor 52 may process trading orders 20 to determine whether trading orders 20 can be satisfied and the order in which trading orders 20 can be satisfied. A trading order 20 may be satisfied in any suitable manner. As an example, a buy order requesting a specific trading amount at a bid price may be satisfied by a sell order that is able to provide the trading amount (or more) at the bid price (or less). As another example, a sell order offering a specific trading amount at an offer price may be satisfied by a buy order that is requesting the specific trading amount (or less) at the offer price (or more).

Establishing whether trading orders 20 can be satisfied may involve placing the trading orders 20 in a processing sequence. A processing sequence may refer to the sequence in which trading orders 20 may be processed. The sequence may be established in any suitable manner. For example, the processing sequence may reflect the sequence that acceptable trading orders 20 are received. According to one embodiment, the first trading order 20 of the processing sequence is processed to establish whether the trading order 20 can be satisfied. The next trading order 20 in the processing sequence is then processed to establish whether the order 20 can be satisfied, and so on.

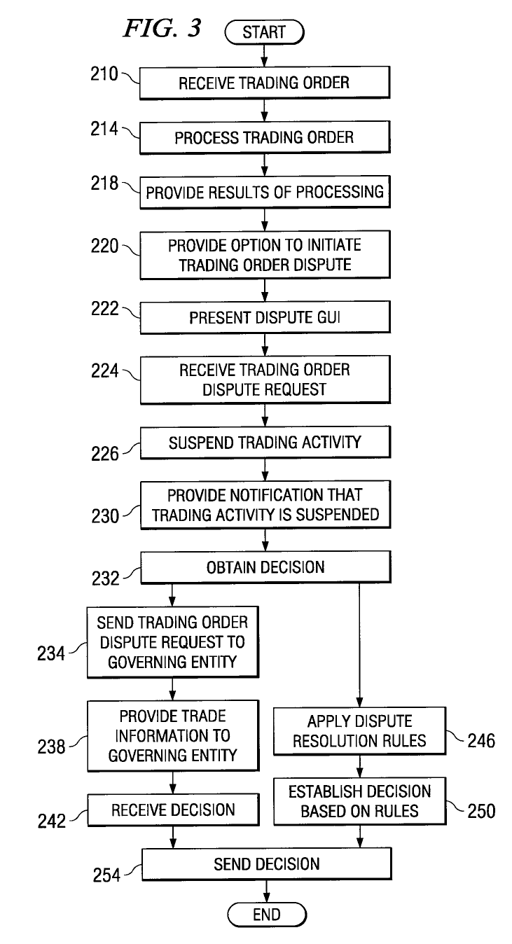

Dispute manager 54 automatically manages trading order dispute requests 26 that raise objections to the processing of particular trading orders 20. Dispute manager 54 may receive trading order dispute request 26, obtain a decision 27 that responds to trading order dispute request 26, and provide the decision 27 to client system 14. An example of a method used by dispute manager 54 is discussed with reference to FIG. 3.

Trading information 42 comprises information that describes trading of a trading order 20, and may include information that may be used to resolve a trading order dispute. According to one embodiment, trading information 42 may be sent to governing entity 22 to aid governing entity 22 in making the decision 27. According to another embodiment, dispute manager 54 may apply rules 38 to trading order 20 and trading information 42 to make the decision 27.

Trading information 42 may include any suitable type of information. As a first example, trading information 42 may include information about trading order 20, such as the trading order parameters, which may be used to respond to an incorrect trading parameters objection. As another example, trading information 42 may include information about the processing of trading orders 20, such as the processing parameters, which may be used to respond to an improper order fill objection. As another example, trading information 42 may include a network management system report of technical problems experienced by trading system 12 or other components in communication with trading system 12, which may be used to respond to a technical problem objection.

Rules 38 may comprise any number and type of rules for resolving trading order disputes. A rule 38 may be applied to trading information 42 and trading order 20 to check whether the trading order 20 was properly processed. An example of a rule 38 may check whether the parameters as stated in a trading order 20 are the same as the parameters used in processing of the trading order 20. Another example of a rule 38 may check whether the processing parameters describing arrival of the trading orders of a processing sequence are the same as the parameters used in processing of the trading orders 20. Another example of a rule 38 may check technical reports to see if a technical problem was encountered during processing of the trading order 20. Rules 38 may comprise any other suitable rules to resolve disputes.

Market centers 18 comprise all manner of order execution venues including exchanges, Electronic Communication Networks (ECNs), Alternative Trading Systems (ATSs), market makers, or any other suitable market participants. Each market center 18 may maintain a bid and offer price for a given trading product by standing ready, willing, and able to buy or sell that trading product at publicly quoted prices, also referred to as market center prices. Different market centers 18 may provide different market center prices for particular trading products. For example, a particular market center 18 may offer a particular bid price and/or offer price for a particular trading product, while another market center 18 may offer a different bid price and/or offer price for the same trading product. A particular market center 18 may charge a transaction cost to execute trading orders 20 that remain in the order books of that market center 18 for more than a certain length of time.

In one example of operation, trader 24 may submit trading order 20. For example, trader 24 may send trading order 20 to buy a trading product that has been trading consistently at $2.00 per share. Trader 24 may receive a confirmation message 25 indicating that trading order 20 was filled. In the example, trading order 20 may be filled at $10.00 per share. Trader 24 may wish to dispute one or more parameters of this transaction, such as the price per share. Confirmation message 25 includes a button that allows trader 24 to submit a trading order dispute request 26.

In response to receiving trading order dispute request 26, dispute manager 54 obtains a decision 27. In one embodiment, dispute manager 54 may forward the trading order dispute request 26 to governing entity 22 empowered to make a decision 27. Governing entity 22 may then send the decision 27 to dispute manager 54, which forwards the decision 27 to client system 14. In another embodiment, dispute manager 54 may apply one or more dispute resolution rules 38 to trading information 42, and establish a decision 27 in accordance with the application of rules 38.

According to one embodiment, the decision 27 may be sent to client system 14 within any appropriate specified period of time after trader 24 has sent a dispute request, for example, less than one hour, less than 30 minutes, less than 20 minutes, less than 15 minutes, less than 10 minutes, less than 5 minutes, or less than 1 minute. That is, the decision 27 may be regarded as automatic.

A decision 27 may perform any suitable function. According to one embodiment, a decision 27 may accept or reject a dispute. Accepting a dispute indicates that the dispute is regarded as valid, and rejecting a dispute indicates that the dispute is regarded as not valid. According to another embodiment, a decision 27 may offer a remedy. Examples of remedies include an apology or financial compensation.

According to yet another embodiment, a decision 27 may request more information (such as more trading information) from trader 24. For example, trader 24 may be asked to verify the time that order 20 was placed. According to yet another embodiment, a decision 27 may cancel trading order 20. According to yet another embodiment, a decision 27 may request that trader 24 resubmit trading order 20. According to yet another embodiment, a decision 27 may request that trader 24 resubmit another dispute request 26.

According to one embodiment, different types of decision 27s may be made. For example, a decision 27 may serve to accept or reject an objection and to offer a remedy. Examples of this type of decision 27 include: accepting the objection and offering a remedy; accepting the objection without offering a remedy; offering a remedy without accepting the objection; and rejecting the objection and not offering a remedy.

Modifications, additions, or omissions may be made to trading system 10 without departing from the scope of the invention. The components of trading system 10 may be integrated or separated according to particular needs. Moreover, the operations of system 10 may be performed by more, fewer, or other modules. Additionally, operations of trading system 10 may be performed using any suitable logic. System 10 may include components operable to perform the functions and operations of the element, such as logic, an interface, memory, other component, or any suitable combination of the preceding.

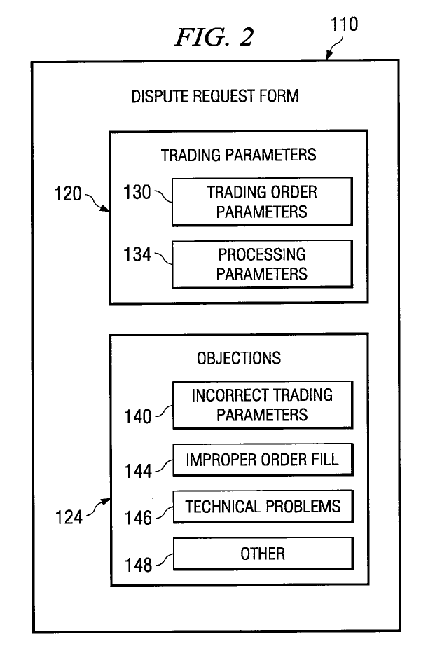

FIG. 2 is a diagram illustrating one embodiment of a graphical user interface (GUI) template 110 that may be used to submit a trading order dispute request 26. A trading order dispute request 26 may include any suitable information and may have any suitable format. According to the illustrated embodiment, GUI template 110 includes a trading parameters section 120 and an objections section 124, which may include buttons. A button may be presented as a graphical element such as a graphical button, menu item, keystroke, or other suitable graphical element.

Trading parameters section 120 displays trading parameters describing the trading of a trading order 20. The trading parameters may describe the disputed trading order 20 and one or more other trading orders 20 that may have been processed along with the disputed trading order 20 in a processing sequence. According to the illustrated embodiment, trading parameters section 120 includes sections for different types of trading parameters, such as a trading order parameters section 130 and a processing parameters section 134.

Trading order parameters section 130 displays trading order parameters, such as the trading order parameters of the disputed trading order 20. Processing parameters section 134 displays processing parameters. Processing parameters describe processing of the disputed trading order and one or more other trading orders 20 that may have been processed along with the disputed trading order. Examples of processing parameters may include the time when the trading orders 20 were placed or filled, the order processor 52 that processed trading orders 20, the market centers 18 involved in the processing of trading orders 20, or other suitable parameters.

Objections section 124 includes objections that may be selected to indicate why a trading order 20 is being disputed. According to the illustrated embodiment, objections section 124 includes an incorrect trading parameters button 140, an improper order fill button 144, a technical problems button 146, and an other button 148.

An incorrect trading parameters button 140 may be used to dispute a trading order 20 based on an incorrect trading parameters objection. An incorrect trading parameters objection may refer to an objection that one or more trading parameters of a trading order 20 are incorrect. If incorrect trading parameters button 140 is selected, a list of trading parameters may be presented. According to one embodiment, trader 24 may select trading parameters that are believed to be incorrect. According to another embodiment, trader 24 may be able to provide what are believed to be correct values of the trading parameters.

Improper order fill button 144 may be used to dispute a trading order 20 based on an improper order fill objection. An improper order fill objection may refer to an objection that the disputed trading order 20 and other orders 20 of the processing sequence were not properly filled according to the processing sequence. As an example, a first order 20 that arrives before a second order 20, but was filled after the second order 20 may have not be properly filled. If improper order fill button 144 is selected, a window in which trader 24 may provide a reason why the filling of orders is improper may be presented. As another example, an order 20 may have been filled at a price that differs from the price expected by trader 24.

A technical problem button 146 may be used to dispute a trading order 20 in which a technical problem was encountered. A technical problem may refer to difficulty with the systems involved in processing trading orders 20. Examples of technical problems include a problem with sending a trading order 20, with receiving the results of processing the trading order 20, with completing a trading order form, or other suitable problem. If technical problems button 146 is selected, a list of common technical problems from which trader 24 may select may be presented. The list may include an “other” option in which trader 24 may provide a description of the technical problem.

Other objection button 148 may be used for objections that are not listed in objections section 124. If other objection button 148 is selected, a window in which trader 24 may describe the objection may be presented.

Modifications, additions, or omissions may be made to GUI template 110 without departing from the scope of the invention. GUI template 110 may include more, fewer, or other fields or values. Additionally, fields or values may be arranged in any suitable manner without departing from the scope of the invention.

FIG. 3 is a flowchart illustrating one embodiment of a method for processing a trading order 20 that may be used with system 10 of FIG. 1. The method begins at step 210, where trading system 12 receives trading order 20 from client system 14 of trader 24. Order processor 52 processes trading order 20 at step 214. Order processor 52 may process trading order 20 along with other trading orders 20. Confirmation message 25 describing the results of processing the trading orders 20 is provided to client system 14 at step 218. Confirmation message 25 may indicate whether trading order 20 has been satisfied by a market center 18.

Confirmation message 25 may provide trader 24 the option to initiate a trade dispute at step 220. Confirmation message 25 may, for example, present a button that may be selected to bring up a dispute GUI. A dispute GUI represented by dispute GUI template 110 may be presented at step 222 in response to selecting the graphical element. The dispute GUI may allow trader 24 to submit a trading order dispute request 26. In some embodiments, a trader 24 may navigate to template 110 to dispute an order 20 separate from confirmation message 25.

A trading order dispute request is received from client system 14 at step 224. Trading activity for trader 24 is suspended at step 226. The trading activity may be suspended after dispute manager 54 has confirmed that the request is satisfactory. For example, a request may be satisfactory if it has been received from an authorized trader 24, is complete, and/or does not raise security alarms. Other client systems 14 involved in the trading activity with the disputed trading order 20 may be notified that trading activity has been suspended at step 230.

Dispute manager 54 obtains a decision 27 regarding the trading order dispute at steps 234 through 250. Steps 234 through 242 describe a first example of obtaining a decision 27, and steps 246 through 250 describe a second example of obtaining a decision 27. At step 234, trading order dispute request 26 is forwarded to governing entity 22. Trading information 42 is provided to governing entity 22 at step 238. Trading information 42 may help governing entity 20 make the decision 27. Dispute manager 54 receives the decision 27 at step 242 from governing entity 22. At step 246, dispute manager 54 applies dispute resolution rules 38 to trading information 42 at step 246. The decision 27 is established based on the rules 38 at step 250.

The decision 27 is sent to client system 14 at step 254. Trader 24 may respond to instructions provided with the decision 27. For example, client system 14 may be provided with information that trader 24 may use to appeal the decision 27. The information may include, for example, instructions for contacting governing entity 22 to appeal the decision 27. Trader 24 may follow the instructions to appeal the decision 27. After the decision 27 is sent, the method ends.

Modifications, additions, or omissions may be made to the method without departing from the scope of the invention. The method may include more, fewer, or other steps. Additionally, steps may be performed in any suitable order without departing from the scope of the invention.

While this disclosure has been described in terms of certain embodiments and generally associated methods, alterations and permutations of the embodiments and methods will be apparent to those skilled in the art. Accordingly, the above description of example embodiments does not constrain this disclosure. Other changes, substitutions, and alterations are also possible without departing from the spirit and scope of this disclosure, as defined by the following claims.

What is claimed is:

1. A system for dispute data transfer in a distributed trading network, the system comprising:
a memory operable to store information about a trading order associated with a client system; and
a dispute manager coupled to the memory and operable to:
communicate a confirmation message to the client system, the confirmation message providing an option to send a trading order dispute request that disputes processing of the trading order;
receive a trading order dispute request generated in response to a selection of the option;
obtain a decision that responds to the trading order dispute request; and
communicate the decision to the client system.

2. The system of claim 1, further comprising an order processor operable to process the trading order by determining whether the trading order can be satisfied.

3. The system of claim 1, wherein the dispute manager is further operable to obtain the decision that responds to the trading order dispute request by:
sending the trading order dispute request to a governing entity empowered to make the decision for the trading order dispute request; and
receiving the decision made by the governing entity.

4. The system of claim 1, wherein the dispute manager is further operable to obtain the decision that responds to the trading order dispute request by providing trading information to a governing entity empowered to make the decision for the trading order dispute request, the trading information describing processing of the trading order.

5. The system of claim 1, wherein the dispute manager is further operable to obtain the decision that responds to the trading order dispute request by:
applying at least one dispute resolution rule; and
establishing the decision in accordance with the application of the at least one dispute resolution rule.

6. The system of claim 1, wherein:
a processing parameter describes the processing of the trading order; and
the trading order dispute request raises an objection to the processing parameter.

7. The system of claim 1, wherein:
the processing of the trading order comprises determining whether the trading order can be satisfied; and
the trading order dispute request raises an objection to the determination.

8. The system of claim 1, wherein:
the processing of the trading order involves communication; and
the trading order dispute request raises an objection indicating a technical problem with the communication.

9. The system of claim 1, wherein the decision performs at least one of the following:
at least partially accept or reject an objection;
offer a remedy;
request more information;
cancel the trading order;
request resubmission of the trading order; and
request resubmission of another dispute request.

10. A method, comprising:
storing information about a trading order associated with a client system;
communicating a confirmation message to the client system, the confirmation message providing an option to send a trading order dispute request that disputes processing of the trading order;
receiving a trading order dispute request generated in response to a selection of the option;
obtaining a decision that responds to the trading order dispute request; and
communicating the decision to the client system.

11. The method of claim 10, further comprising processing the trading order by determining whether the trading order can be satisfied.

12. The method of claim 10, further comprising obtaining the decision that responds to the trading order dispute request by:
sending the trading order dispute request to a governing entity empowered to make the decision for the trading order dispute request; and
receiving the decision made by the governing entity.

13. The method of claim 10, further comprising obtaining the decision that responds to the trading order dispute request by providing trading information to a governing entity empowered to make the decision for the trading order dispute request, the trading information describing processing of the trading order.

14. The method of claim 10, further comprising obtaining the decision that responds to the trading order dispute request by:
applying at least one dispute resolution rule; and
establishing the decision in accordance with the application of the at least one dispute resolution rule.

15. The method of claim 10, wherein:
a processing parameter describes the processing of the trading order; and
the trading order dispute request raises an objection to the processing parameter.

16. The method of claim 10, wherein:
the processing of the trading order comprises determining whether the trading order can be satisfied; and
the trading order dispute request raises an objection to the determination.

17. The method of claim 10, wherein:
the processing of the trading order involves communication; and
the trading order dispute request raises an objection indicating a technical problem with the communication.

18. The method of claim 10, wherein the decision performs at least one of the following:
at least partially accept or reject an objection;
offer a remedy;
request more information;
cancel the trading order;
request resubmission of the trading order; and
request resubmission of another dispute request.

19. A system, comprising:
means for storing information about a trading order associated with a client system;
means for communicating a confirmation message to the client system, the confirmation message providing an option to send a trading order dispute request that disputes processing of the trading order;
means for receiving a trading order dispute request generated in response to a selection of the option;
means for obtaining a decision that responds to the trading order dispute request; and
means for communicating the decision to the client system.

20. A system, comprising:
a memory operable to:
store information about a trading order associated with a client system; and
a dispute manager coupled to the memory and operable to:
receive a trading order dispute request generated in response to selection of the option;
process the trading order by:
determining whether the trading order can be satisfied;
communicate a confirmation message to the client system, the confirmation message providing an option to send a trading order dispute request that disputes processing of the trading order;
receive a trading order dispute request generated in response to a selection of the option;
obtain a decision that responds to the trading order dispute request by:
sending the trading order dispute request to a governing entity empowered to make the decision for the trading order dispute request;
providing trading information to the governing entity, the trading information describing processing of the trading order;
receiving the decision made by the governing entity;
applying at least one dispute resolution rule; and
establishing the decision in accordance with the application of the at least one dispute resolution rule; and
communicate the decision to the client system.
